(19) United States
(12) Patent Application Publication
(10) Pub. No.: US 2024/0080702 A1
(43) Pub. Date: Mar. 7, 2024

(54) COMMUNICATION CONTROL DEVICE, SYSTEM, AND METHOD

(71) Applicant: TOYOTA JIDOSHA KABUSHIKI KAISHA, Toyota-shi (JP)

(72) Inventors: Toshiki SHINOHARA, Toyota-shi (JP); Masataka OKUDA, Toyota-shi (JP); Masatoshi KAKUTANI, Miyoshi-shi (JP); Kaoru YOSHIDA, Nisshin-shi (JP); Kanade KURIYAMA, Toyota-shi (JP)

(73) Assignee: TOYOTA JIDOSHA KABUSHIKI KAISHA, Toyota-shi (JP)

(21) Appl. No.: 18/217,879

(22) Filed: Jul. 3, 2023

(30) Foreign Application Priority Data
Sep. 7, 2022 (JP) 2022-142308

(51) Int. Cl. H04W 28/02; H04L 5/00; H04W 72/0453; H04W 76/15

(52) U.S. Cl. CPC H04W 28/0226; H04L 5/0048; H04W 72/0453; H04W 76/15

(57) ABSTRACT

A communication control device for performing communication with a plurality of vehicles, comprising: a communication unit that performs communication including acquisition of vehicle data with a plurality of vehicles; a database that stores data for forming a digital twin that is time-synchronized with a real space on a virtual space based on vehicle data acquired by the communication unit; and a control unit that controls a frequency of communication performed by the communication unit, wherein when there is a first vehicle in which a distance from a surrounding object is less than a first threshold value on the digital twin, the control unit increases a frequency of communication performed between the first vehicle and the surrounding object than when the distance between the first vehicle and the surrounding object is equal to or greater than the first threshold value.

### CROSS-REFERENCE TO RELATED APPLICATION

This application claims priority to Japanese Patent Application No. 2022-142308 filed on Sep. 7, 2022, incorporated herein by reference in its entirety.

### BACKGROUND

### 1. Technical Field

The present disclosure relates to a communication control device and the like for controlling communication with a plurality of vehicles.

### 2. Description of Related Art

Japanese Unexamined Patent Application Publication No. 2020-013557 (JP 2020-013557 A) discloses a system in which a server receives digital data (vehicle data) describing a state of a vehicle and a behavior of the vehicle from a plurality of vehicles and updates a digital twin based on the received vehicle data.

### SUMMARY

If the server performs communication with all of the plurality of vehicles at a uniform high frequency, the amount of communication between the server and the vehicles increases, resulting in compression of a communication band (shortage of communication resources) and an increase in communication cost. Further, there is a possibility that the quality of the digital twin deteriorates due to the delay in the processing of the vehicle data. Therefore, there is room for study on a method of communication performed between the server and the vehicle.

The present disclosure has been made in view of the above problems, and an object thereof is to provide a server (communication control device) and the like capable of securing the quality of a digital twin and suppressing an increase in communication cost.

A communication control device according to a first aspect of the present disclosure is a communication control device that performs communication with a plurality of vehicles. The communication control device includes: a communication unit that performs communication including acquisition of vehicle data with the plurality of vehicles; a database that stores data for forming, on a virtual space, a digital twin that is time-synchronized with a real space, based on the vehicle data acquired by the communication unit; and a control unit that controls a frequency of communication performed by the communication unit. When there is a first vehicle of which a distance from a surrounding object is less than a first threshold value on the digital twin, the control unit increases the frequency of the communication performed with the first vehicle than when the distance between the first vehicle and the surrounding object is equal to or greater than the first threshold value.

According to the communication control device and the like of the present disclosure, since the frequency of communication with the vehicle is dynamically changed in accordance with the distance between the vehicle and the surrounding object on the digital twin, it is possible to secure the quality of the digital twin and to suppress an increase in the communication cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a digital twin system including a communication control device according to an embodiment of the present disclosure;

FIG. 2A is a flowchart of a first example of data communication control executed by a communication control device;

FIG. 2B is a flowchart of a first example of data communication control executed by a communication control device;

FIG. 3 is an image diagram illustrating a relationship between digital twin behavior and data communication when a communication pattern is low;

FIG. 4 is an image diagram illustrating a relationship between digital twin behavior and data communication at medium speed in a communication pattern;

FIG. 5 is an image diagram illustrating a relationship between digital twin behavior and data communication when a communication pattern is high speed;

FIG. 6 is a processing flowchart of a second example of data communication control executed by the communication control device, and is a processing flowchart of upload control;

FIG. 7 is a processing flowchart of a second example of data communication control executed by the communication control device, and is a processing flowchart of download control;

FIG. 8 is a diagram illustrating an example of a communication pattern table for upload; and

FIG. 9 is a diagram illustrating an example of a communication pattern table for downloading.

### DETAILED DESCRIPTION OF EMBODIMENTS

The communication control device of the present disclosure changes the frequency of communicating with the real vehicle according to the state of the virtual vehicle on the digital twin. Accordingly, it is possible to suitably control the quality assurance of the digital twin and the suppression of the increase in the communication cost according to the state of the vehicle.

Hereinafter, an embodiment of the present disclosure will be described in detail with reference to the drawings.

### EMBODIMENT

### Configuration

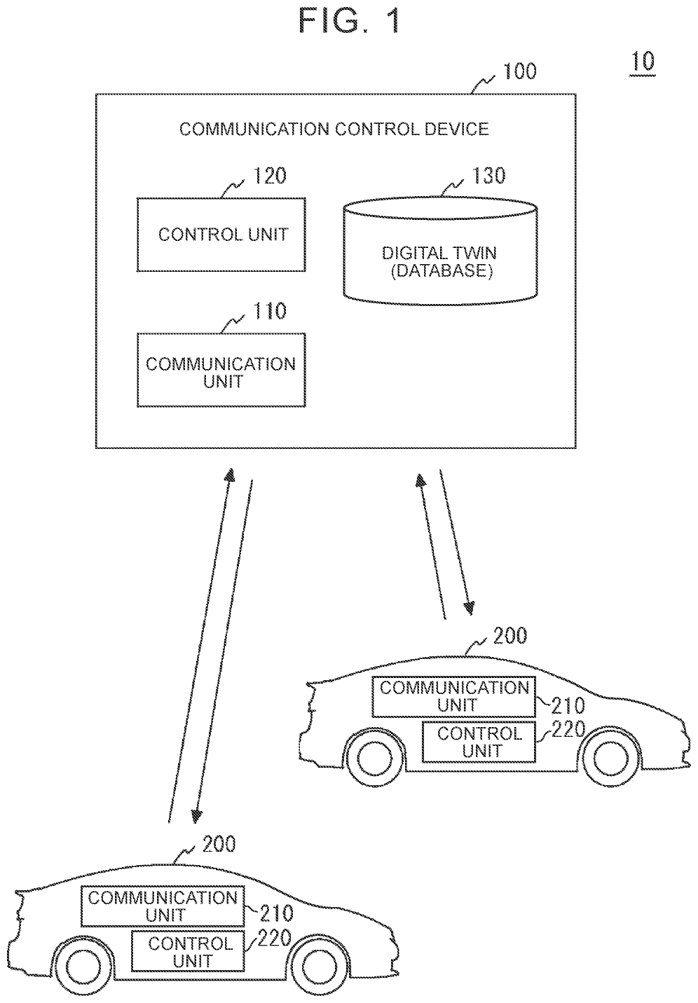

FIG. 1 is a schematic diagram illustrating an overall configuration example of a digital twin system 10 including a communication control device 100 according to an embodiment of the present disclosure. The digital twin system 10 illustrated in FIG. 1 includes a communication control device 100 and a plurality of vehicles 200. The communication control device 100 and the plurality of vehicles 200 are communicably connected directly or via a communication base station (not shown).

### Communication Control Device

The communication control device 100 is configured to be able to communicate with a plurality of vehicles 200. The communication control device 100 can provide, for example, a predetermined service (traffic control service or the like) to a specific vehicle 200 based on vehicle data including information on the state of the host vehicle acquired from each of the plurality of vehicles 200. As the communication control device 100, a cloud server configured on a cloud can be exemplified.

The communication control device 100 includes a communication unit 110, a control unit 120, and a digital twin 130. The communication control device 100 is typically configured to include a processor such as a Central Processing Unit (CPU, a memory such as a Random Access Memory (RAM, a readable/writable storage medium such as a hard disk drive (HDD) or a solid state drive (SSD), an input/output interface, and the like, and realizes all or a part of functions performed by the communication unit 110 and the control unit 120 by the processor reading and executing a program stored in the memory.

The communication unit 110 is configured to perform communication with the plurality of vehicles 200, and receive (acquire) vehicle data including information on the state of the host vehicle (the position, speed, traveling direction, and the like of the vehicle), data related to the generation of the digital twin 130 (data related to the surroundings of the vehicle, data related to the communication quality, and the like), and communication requests related to predetermined services from the plurality of vehicles 200 and the like. In addition, the communication unit 110 can transmit information, data, a control instruction, and the like necessary for a predetermined service to the vehicle 200 that has transmitted the communication request among the plurality of vehicles 200.

The control unit 120 controls the entire communication control device 100 including communication with the plurality of vehicles 200, management of the digital twin 130, and the like. In particular, the control unit 120 of the present embodiment dynamically controls a communication pattern (a communication interval, the number of times of communication, and the like) which is a frequency of communication performed between the communication control device 100 and the vehicle 200 based on vehicle data received (acquired) from the vehicle 200 by the communication unit 110 and a communication request. The control of the communication pattern performed by the control unit 120 will be described later.

The digital twin 130 is a database for reproducing a virtual world (virtual space) time-synchronized with a real world (real space) on a cloud computer by updating and storing data related to current and past vehicle states acquired (collected) from a plurality of vehicles 200 in real time. In the digital twin 130, it is possible to generate a traffic digital twin in which an object (a moving object/a stationary object) on a traveling road and a traffic situation are all copied in a place (a road, a parking lot, or the like) where a vehicle participating in the digital twin system 10 including a plurality of vehicles 200 can travel. Examples of the information included in the data stored in the digital twin 130 include vehicle information (VIN and the like), information on other vehicles (including a bicycle, a pedestrian, and the like), map information, time information (time stamp), position information (GPS latitude/longitude), and trajectory information (vehicle speed, direction, and the like) that is a travel track.

### Vehicle

The vehicle 200 is a mobility configured to be able to communicate with the communication control device 100. The vehicle 200 can provide the communication control device 100 with information related to the state of the host vehicle and data necessary for generating the digital twin 130 constructed in the communication control device 100. The number of vehicles 200 that communicate with the communication control device 100 is not particularly limited.

The vehicle 200 includes a communication unit 210 and a control unit 220. These configurations may typically be configured as processors such as CPU, memories such as RAM, readable and writable storage media such as hard disk drives and solid state drives, and Electronic Control Unit (ECU including input/output interfaces and the like. The electronic control unit realizes all or a part of the functions performed by the communication unit 210 and the control unit 220 by the processor reading and executing a program stored in the memory.

The communication unit 210 is configured to execute communication with the communication control device 100, and transmit vehicle data including information on the state of the host vehicle, data related to the generation of the digital twin 130, and the like, and a communication request related to a predetermined service to the communication control device 100. The information related to the state of the own vehicle includes the position of the vehicle, the speed of the vehicle, the traveling direction of the vehicle, and the like. The data necessary for generating the digital twin 130 includes data related to other vehicles, such as other vehicles, buildings, and pedestrians, which are objects existing around the vehicle 200. Various sensors (not shown) mounted on the vehicle 200 can be used to acquire these pieces of information and data. In addition, the communication unit 210 can receive information, data, control instructions, and the like necessary for a predetermined service transmitted from the communication control device 100 in response to a communication request.

The control unit 220 manages overall control of the vehicle 200 including communication with the communication control device 100, control of vehicle travel, and the like. In particular, the control unit 220 of the present embodiment changes the frequency of communication to be executed with the communication control device 100 based on the control (instruction) of the communication control device 100.

### Control

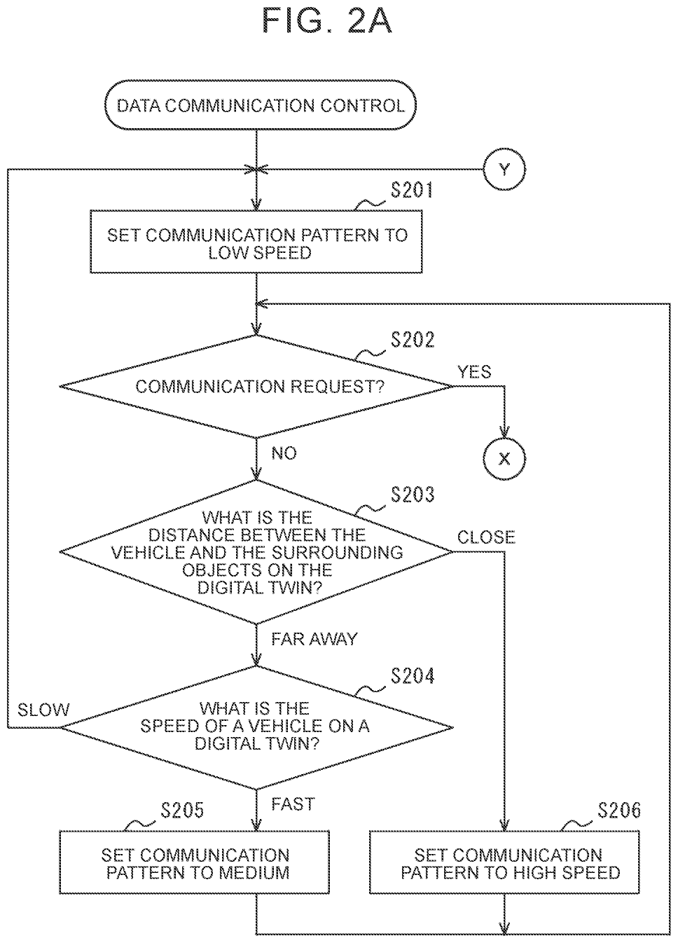

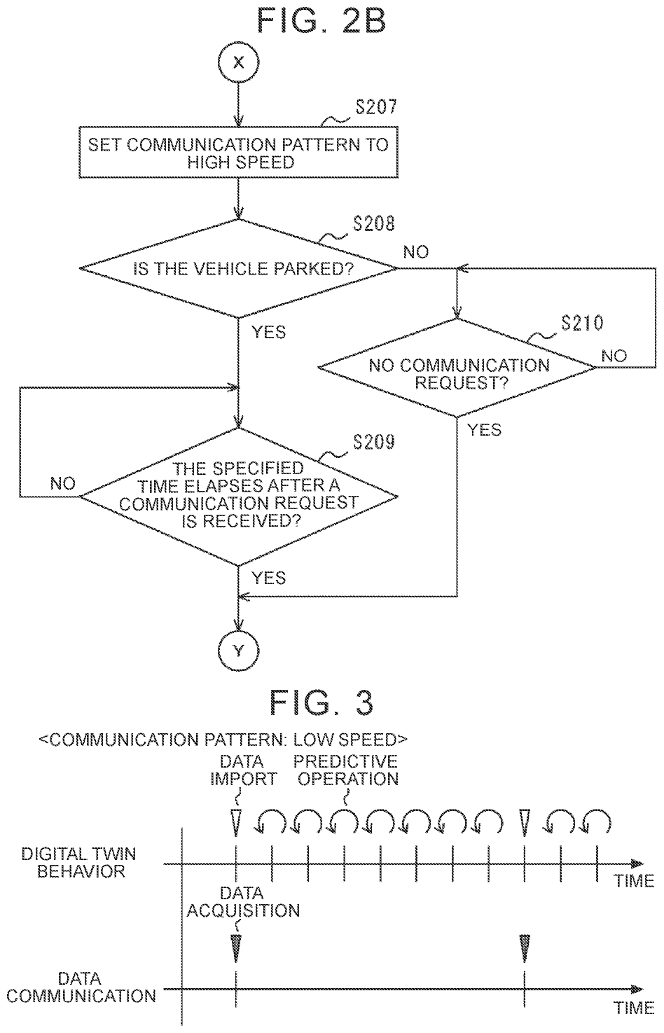

Next, some of the control executed by the communication control device 100 according to the present embodiment will be described with reference to FIGS. 2A to 9.

### First Example of Data Communication Control

FIGS. 2A and 2B are flow charts for explaining the process of the first exemplary data communication control executed by the communication control device 100. The process of FIG. 2A and the process of FIG. 2B are connected by connections X and Y. The data communication control illustrated in FIGS. 2A and 2B is started individually for the vehicles 200 in which communication with the communication control device 100 is established, and is repeatedly performed until the communication is interrupted.

### S201

The control unit 120 of the communication control device 100 sets the communication pattern, which is the frequency of data communication to be executed between the communication control device 100 and the vehicle 200, to “low speed” as an initial state. The set communication pattern is notified from the communication control device 100 to the vehicle 200. The relationship between the behavior of the digital twin 130 and the data communication when the communication pattern is set to a low speed is shown in the image of FIG. 3. In the low-speed communication pattern illustrated in FIG. 3, the communication control device 100 performs the prediction calculation based on the latest data seven times in a period from the vehicle 200 until new data is acquired by data communication. As described above, the communication cost can be reduced by reducing the communication frequency at which data is acquired from the vehicle 200. When the control unit 120 sets the communication pattern to a low speed, the process proceeds to S202.

### S202

The communication unit 110 of the communication control device 100 determines whether or not a communication request related to the vehicle 200 has been received. Examples of the communication request include a transmission request for data necessary for receiving the traffic control service. In addition to being transmitted from the communication unit 210 of the vehicle 200, the communication request may be transmitted from a terminal device (a smartphone, a personal computer, or the like) possessed by a user of the vehicle 200 or the like. When the communication unit 110 receives a communication request related to the vehicle 200 (corresponding to the third vehicle in the claims), (S202, Yes), the process proceeds to S207. On the other hand, if the communication unit 110 has not received a communication request related to the vehicle 200 (S202, No), the process proceeds to S203.

### S203

When the communication request related to the vehicle 200 has not been received, the control unit 120 of the communication control device 100 refers to the digital twin 130 and determines the distance between the vehicle 200 and the surrounding object (other vehicle, building, pedestrian, etc.) on the digital twin (virtual world). More specifically, the control unit 120 can determine that both are in a distant positional relationship when the distance between the vehicle 200 and the surrounding object is equal to or greater than the first threshold, and that both are in a close positional relationship when the distance is less than the first threshold. This determination is made to determine whether surrounding objects may affect the travel of the vehicle 200. Therefore, the first threshold value is set to an appropriate distance in consideration of the degree of influence of the surrounding object on the vehicle 200 and the like. When the control unit 120 determines that the distance between the vehicle 200 and the surrounding object on the digital twin is long (S203, long), the process proceeds to S204. On the other hand, when the control unit 120 determines that the distance between the vehicle 200 (corresponding to the first vehicle in the claims) on the digital twin and the surrounding object is close (S203, close), the process proceeds to S206.

### S204

The control unit 120 of the communication control device 100 further refers to the digital twin 130 to determine the speed of the vehicle 200 on the digital twin (virtual world). More specifically, the control unit 120 can determine that the speed of the vehicle 200 is high, for example, when the speed is equal to or higher than the second threshold value, and determines that the speed is low, for example, when the speed is lower than the second threshold value. This determination is made in order to determine the influence of the speed of the vehicle 200 on the travel. Therefore, the second threshold value is set to an appropriate speed in consideration of the degree of influence on the vehicle 200 by the speed, and the like. When the control unit 120 determines that the speed of the vehicle 200 (corresponding to the second vehicle in the claims) on the digital twin is high (S204, high), the process proceeds to S205. On the other hand, if the control unit 120 determines that the velocity of the vehicles 200 on the digital twin is slow (S204, slow), the process proceeds to S201.

### S205

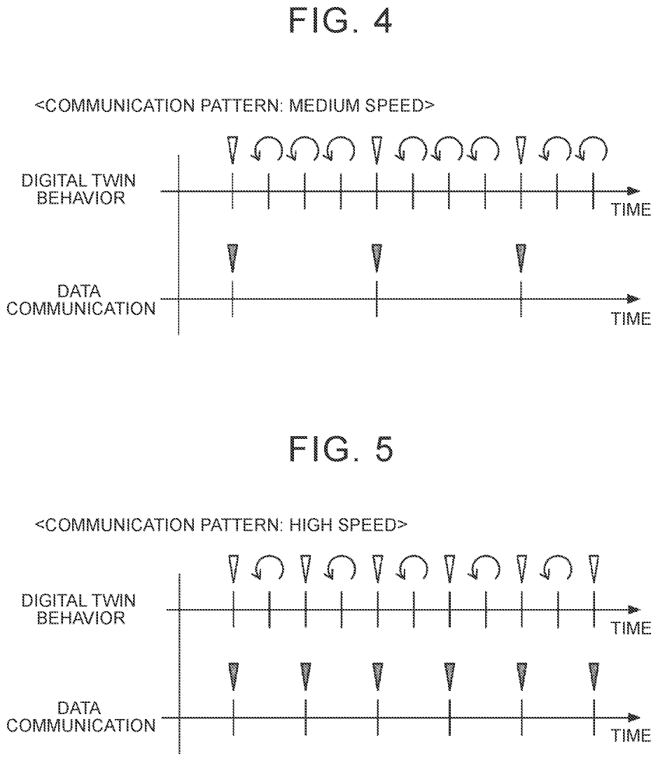

The control unit 120 of the communication control device 100 sets the communication pattern, which is the frequency of data communication to be executed between the communication control device 100 and the vehicle 200, to “medium speed”. The set communication pattern is notified from the communication control device 100 to the vehicle 200. The relationship between the behavior of the digital twin 130 and the data communication when the communication pattern is set to the medium speed is shown in the image of FIG. 4. In the medium-speed communication pattern illustrated in FIG. 4, the communication control device 100 performs the prediction calculation based on the latest data three times in a period from the vehicle 200 until new data is acquired by data communication. As described above, by increasing the communication frequency for acquiring data from the vehicle 200 as compared with the low-speed communication pattern, it is possible to suppress an increase in the communication cost while securing the data quality of the digital twin 130. When the control unit 120 sets the communication pattern to the medium speed, the process proceeds to S202.

### S206

The control unit 120 of the communication control device 100 sets the communication pattern, which is the frequency of data communication to be executed between the communication control device 100 and the vehicle 200, to “high speed”. The set communication pattern is notified from the communication control device 100 to the vehicle 200. The relationship between the behavior of the digital twin 130 and data communication when the communication pattern is set to a high speed is illustrated by the image of FIG. 5. In the high-speed communication pattern illustrated in FIG. 5, the communication control device 100 performs the prediction calculation based on the latest data only once in a period from the vehicle 200 until new data is acquired by data communication. As described above, by increasing the communication frequency for acquiring data from the vehicle 200 as compared with the low-speed and medium-speed communication patterns, it is possible to give priority to securing the data quality of the digital twin 130 over the communication cost. When the control unit 120 sets the communication pattern at a high speed, the process proceeds to S202.

### S207

When the communication request related to the vehicle 200 is received, the control unit 120 of the communication control device 100 immediately sets the communication pattern, which is the frequency of data communication to be executed between the communication control device 100 and the vehicle 200, to “high speed” in order to give priority to this request. The relationship between the behavior of the digital twin 130 and the data communication when the communication pattern is set at a high speed is as shown in FIG. 5. When the control unit 120 sets the communication pattern at a high speed, the process proceeds to S208.

### S208

The control unit 120 of the communication control device 100 determines whether or not the vehicle 200 is parked. Whether or not the vehicle 200 is parked can be determined based on the state of the ignition switch obtained by the vehicle data, the activation state of the vehicle system, and the like. When the control unit 120 determines that the vehicle 200 is parking (S208, Yes), the process proceeds to S209. On the other hand, when the control unit 120 determines that the vehicle 200 is not parked (S208, No), the process proceeds to S210.

### S209

The control unit 120 of the communication control device 100 determines whether or not a predetermined time has elapsed since the reception of the communication request related to the vehicle 200. Typically, the content of a communication request sent for a parked vehicle 200 is expected to be a short-term service, such as temporarily checking the current state of the vehicle 200, rather than a long-term service requiring continuous communication, such as a traffic control service. Therefore, this determination is made in order to make the high-speed setting of the communication pattern time-limited by using a predetermined time. When the control unit 120 determines that the predetermined time has elapsed since the reception of the communication request (S209, Yes), the process proceeds to S201. On the other hand, when the control unit 120 determines that the predetermined time has not elapsed since the reception of the communication request (S209, No), the control unit waits until the predetermined time has elapsed.

### S210

The control unit 120 of the communication control device 100 determines whether or not a communication request related to the vehicle 200 has disappeared. Typically, the content of a communication request sent for a vehicle 200 that is not parked is considered to be a long-term service that requires continuous communication, such as a traffic control service. Therefore, this determination is made in order to maintain the high-speed setting of the communication pattern until the communication request disappears. If the control unit 120 determines that there is no longer a communication request (S210, Yes), the process proceeds to S201. On the other hand, when the control unit 120 determines that the communication request is continuing (S210, No), it waits until the communication request disappears.

According to the first example of the data communication control described above, the communication frequency of data communication in the downlink direction (download) from the communication control device 100 to the vehicle 200 and the communication frequency of data communication in the uplink direction (upload) from the vehicle 200 to the communication control device 100 can be controlled together in accordance with the distance between the vehicle 200 and the surrounding object and the speed of the vehicle 200.

It should be noted that S210 from the above S201 is preferably performed by synchronizing the timings at which the digital twin 130 updates data. In addition, the determination of the presence or absence of a communication request performed by S202 may be performed at a timing different from the timing indicated by the data communication control flowchart. Further, although an example has been described in which the initial setting of the communication pattern is set to a low speed and is changed to a medium speed or a high speed according to a subsequent determination, the high speed may be controlled to be changed to a low speed or a medium speed according to a subsequent determination as an initial setting of the communication pattern. Further, the number and the interval of the communication patterns to be changed are not limited to the low speed, the medium speed, and the high speed shown in FIGS. 3 to 5, and can be appropriately set in accordance with the performance and specifications of the digital twin system 10.

### Second Example of Data Communication Control

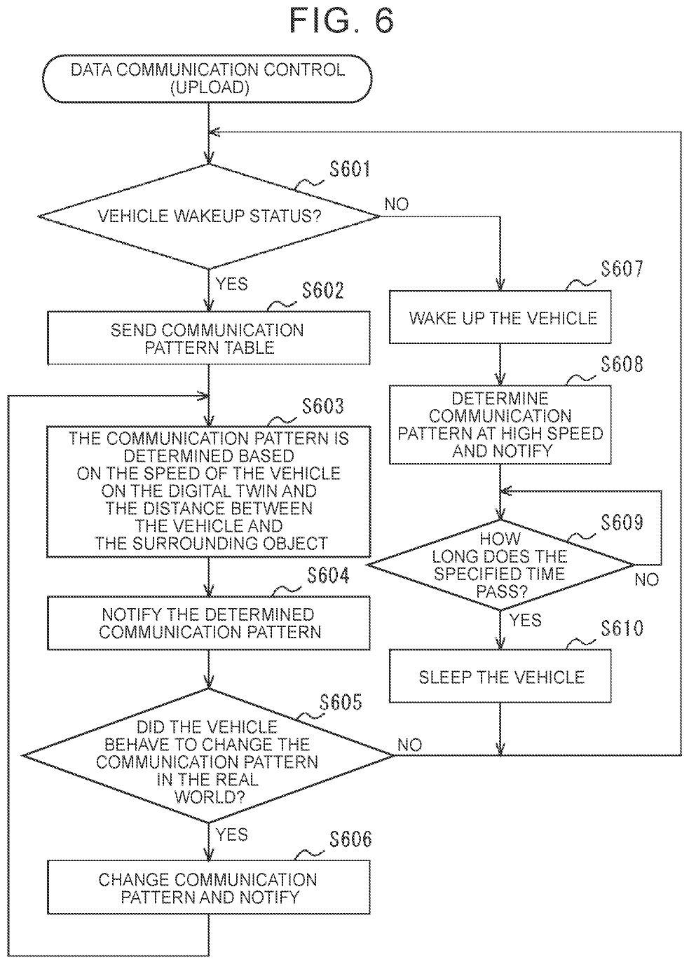

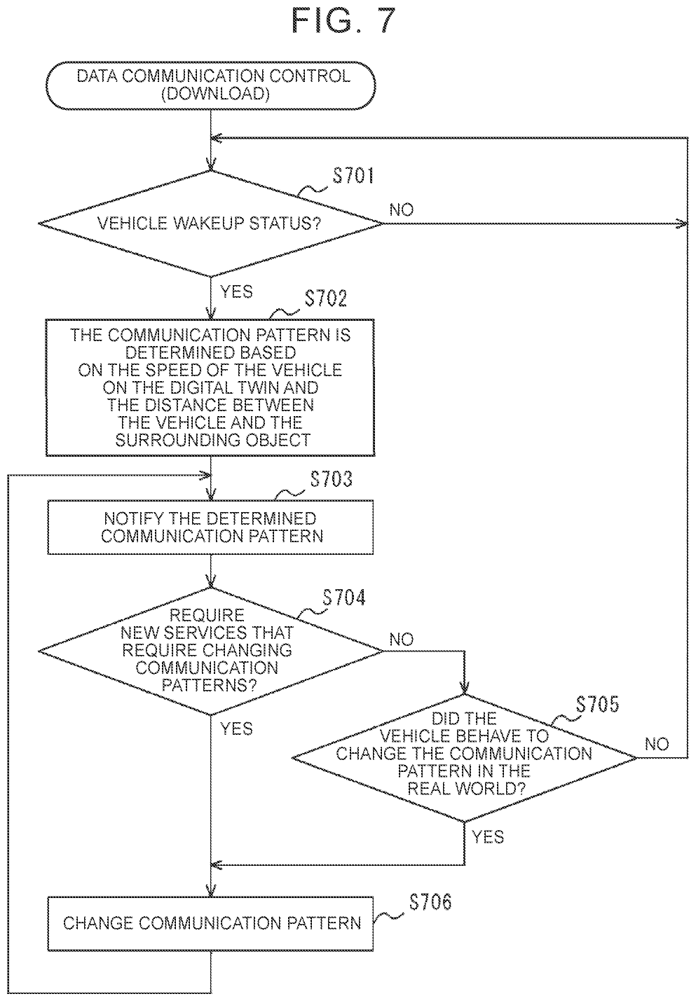

FIG. 6 and FIG. 7 are flowcharts for explaining a processing procedure of a second example of data communication control executed by the communication control device 100. FIG. 6 is a flowchart of the upload side executed by the communication control device 100, and FIG. 7 is a flowchart of the download side executed by the communication control device 100. The data communication control illustrated in FIGS. 6 and 7 is started individually for the vehicle 200 in which communication with the communication control device 100 is established, and is repeatedly performed until the communication is interrupted.

### Upload

### S601

The control unit 120 of the communication control device 100 determines whether or not the vehicle 200 is in the wake-up state. The wakeup state refers to a state in which the vehicle 200 can be moved at any time by the user's intention, such as a state of engine ON (ignition ON) in an internal combustion engine vehicle and a state of Ready-ON in a electrified vehicle. When the control unit 120 determines that the vehicle 200 is in the wake-up status (S601, Yes), the process proceeds to S602. On the other hand, when the control unit 120 determines that the vehicle 200 is not in the wake-up status (S601, No), the process proceeds to S607.

### S602

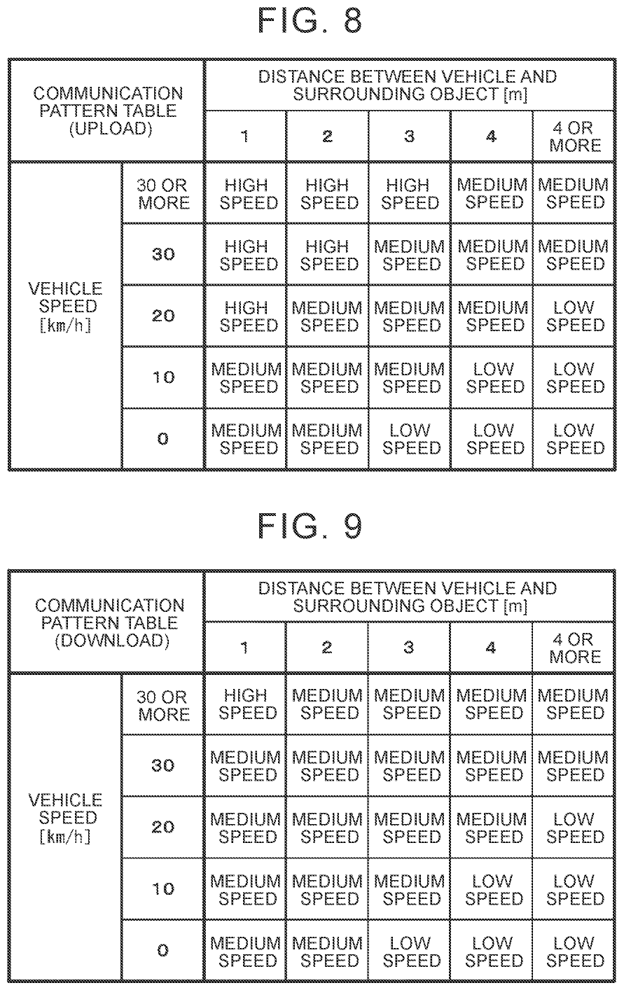

The communication unit 110 of the communication control device 100 transmits a table indicating a communication pattern for upload to the vehicle 200. FIG. 8 illustrates a communication pattern table for upload. The communication pattern table (upload) illustrated in FIG. 8 is a two-dimensional table using the speed of the vehicle 200 and the distance between the vehicle 200 and the surrounding object as parameters. For example, in FIG. 8, if the velocity of the vehicle 200 is greater than or equal to 20 km/h and less than 30 km/h, and the distance between the vehicle 200 and the surrounding object is greater than or equal to 1 m and less than 2 m, the communication pattern is set to “high speed”. When the communication unit 110 transmits the communication pattern table (upload) to the vehicles 200, the process proceeds to S603.

### S603

The control unit 120 of the communication control device 100 refers to the digital twin 130 and determines a communication pattern to be applied at the time of upload based on the speed of the vehicle 200 on the digital twin (virtual world) and the distance between the vehicle 200 and the surrounding object. In FIG. 8, V=0 km/h, 0 km/h<V≤10 km/h, km/h<V≤20 km/h, 20 km/h<V≤30 km/h, and 30 km/h<V are classified as the velocity V of the vehicles 200. Further, D<1 m, 1 m<D2 m, 2 m<D3 m, 3 m<D4 m, and 4 m<D are classified as distances D between the vehicles 200 and surrounding objects. The control unit 120 determines a communication pattern to be applied at the time of upload according to which of these categories belongs. When the control unit 120 determines the communication pattern to be applied at the time of uploading, the process proceeds to S604.

### S604

The communication unit 110 of the communication control device 100 notifies (transmits) the vehicle 200 of the communication pattern to be applied at the time of upload determined by the control unit 120. When the control unit 120 notifies the vehicle 200 of the communication pattern to be applied at the time of uploading, the process proceeds to S605.

### S605

The control unit 120 of the communication control device 100 determines whether or not the vehicle 200 has taken the action of changing the communication pattern in the real world. Examples of the behavior in which the communication pattern should be changed include rapid acceleration and shortening of the inter-vehicle distance. These behaviors can be determined based on vehicle data. When the control unit 120 determines that the vehicle 200 has taken the action to change the communication pattern (S605, Yes), the process proceeds to S606. On the other hand, when the control unit 120 determines that the vehicle 200 does not take the action to change the communication pattern (S605, No), the process proceeds to S601.

### S606

The control unit 120 of the communication control device 100 changes the communication pattern to be applied at the time of the current upload based on the communication pattern table for upload (FIG. 8), and notifies (transmits) the changed communication pattern to the vehicle 200. When the control unit 120 changes the communication pattern to be applied at the time of uploading and notifies the vehicles 200, the process proceeds to S603.

### S607

The control unit 120 of the communication control device 100 causes the vehicle 200 to wake up. The wake-up may be directly applied to the vehicle 200, or may be performed by the user by notifying a terminal device or the like possessed by the user of the vehicle 200. When the control unit 120 causes the vehicles 200 to wake up, the process proceeds to S608.

### S608

The control unit 120 of the communication control device 100 determines the communication pattern to be applied at the time of upload as “high speed” and notifies the vehicle 200 of the determined communication pattern. When the control unit 120 determines the communication pattern at a high speed and notifies the vehicle 200 of the communication pattern, the process proceeds to S609.

### S609

The control unit 120 of the communication control device 100 determines whether or not a predetermined time has elapsed after the communication pattern to be applied at the time of upload is determined to be “high speed”. If the control unit 120 determines that the predetermined period has elapsed since the communication pattern was determined to be “high speed” (S609, Yes), the process proceeds to S610. On the other hand, when the control unit 120 determines that the predetermined time has not elapsed since the communication pattern was determined to be “high speed” (S609, No), the control unit waits until the predetermined time has elapsed.

The control unit 120 of the communication control device 100 causes the vehicle 200 to sleep. The sleep may be directly applied to the vehicle 200, or may be performed by the user by notifying a terminal device or the like possessed by the user of the vehicle 200. When the control unit 120 causes the vehicles 200 to sleep, the process proceeds to S601.

### Download

### S701

The control unit 120 of the communication control device 100 determines whether or not the vehicle 200 is in the wake-up state. This wakeup state is as described above. When the control unit 120 determines that the vehicle 200 is in the wake-up status (S701, Yes), the process proceeds to S702. On the other hand, when the control unit 120 determines that the vehicle 200 is not in the wake-up state (S701, No), it waits until the vehicle 200 is in the wake-up state.

### S702

The control unit 120 of the communication control device 100 refers to the digital twin 130 and determines a communication pattern to be applied at the time of downloading based on the speed of the vehicle 200 on the digital twin (virtual world) and the distance between the vehicle 200 and the surrounding object. FIG. 9 illustrates a communication pattern table for download. The communication pattern table (download) illustrated in FIG. 9 is a two-dimensional table using the speed of the vehicle 200 and the distance between the vehicle 200 and the surrounding object as parameters. In FIG. 9, V=0 km/h, 0 km/h<V≤10 km/h, 10 km/h<V≤20 km/h, 20 km/h<V≤30 km/h, and 30 km/h<V are classified as the velocity V of the vehicles 200. Further, D<1 m, 1 m<D≤2 m, 2 m<D≤3 m, 3 m<D≤4 m, and 4 m<D are classified as distances D between the vehicles 200 and surrounding objects. The control unit 120 determines a communication pattern to be applied at the time of downloading according to which of these categories belongs. For example, in FIG. 9, if the velocity of the vehicle 200 is greater than or equal to 20 km/h and less than km/h, and the distance between the vehicle 200 and the surrounding object is greater than or equal to 1 m and less than 2 m, the communication pattern is set to “medium speed”. A plurality of communication pattern tables may be provided depending on the service, or only one common to the plurality of services may be provided. When the control unit 120 determines the communication pattern to be applied at the time of downloading, the process proceeds to S703.

### S703

The communication unit 110 of the communication control device 100 notifies (transmits) the vehicle 200 of the communication pattern to be applied at the time of download determined by the control unit 120. When the control unit 120 notifies the vehicle 200 of the communication pattern to be applied at the time of downloading, the process proceeds to S704.

### S704

The communication unit 110 of the communication control device 100 determines whether or not a service requiring a change in the communication pattern is newly requested from the vehicle 200 or the like. As the service requiring the change of the communication pattern, a traffic control service can be exemplified. When the communication unit 110 determines that a service requiring a change in the communication pattern is newly requested (S704, Yes), the process proceeds to S706. On the other hand, if the communication unit 110 determines that a service requiring a change in the communication pattern is not newly requested (S704, No), the process proceeds to S705.

### S705

The control unit 120 of the communication control device 100 determines whether or not the vehicle 200 has taken the action of changing the communication pattern in the real world. The behavior in which the communication pattern should be changed is as described above. When the control unit 120 determines that the vehicle 200 has taken the action to change the communication pattern (S705, Yes), the process proceeds to S706. On the other hand, when the control unit 120 determines that the vehicle 200 does not take the action to change the communication pattern (S705, No), the process proceeds to S701.

### S706

The control unit 120 of the communication control device 100 changes the communication pattern to be applied at the time of the current download based on the communication pattern table for download (FIG. 9). When the control unit 120 changes the communication pattern to be applied at the time of downloading, the process proceeds to S703.

According to the second example of the data communication control described above, the communication frequency of data communication in the downlink direction (download) from the communication control device 100 to the vehicle 200 and the communication frequency of data communication in the uplink direction (upload) from the vehicle 200 to the communication control device 100 can be individually controlled in accordance with the distance between the vehicle 200 and the surrounding object and the speed of the vehicle 200.

It should be noted that the flow of S610 and the flow of S706 from S701 from the above S601 are preferably performed by synchronizing the timings at which the digital twin 130 updates data. Further, the classification of each parameter and the number and interval of the communication patterns in the communication patterns shown in FIGS. 8 and 9 are examples, and can be appropriately set according to the performance, specifications, and the like of the digital twin system 10.

### Effects, etc.

As described above, according to the communication control device 100 according to the embodiment of the present disclosure, the distance between the vehicle 200 on the virtual world constructed in the digital twin 130 and the surrounding object and the speed of the vehicle 200 are determined, and the communication pattern, which is the frequency of data communication to be executed between the communication control device 100 and the vehicle 200 in the real world, is dynamically changed.

By this control, it is possible to increase the speed of the communication pattern to give priority to securing the quality of the digital twin 130 in a situation where continuous communication is required, such as a traffic control service, and to reduce the speed of the communication pattern in other situations to suppress an increase in the communication cost. Therefore, it is possible to suitably control the quality assurance of the digital twin 130 and the suppression of the increase in the communication cost according to the communication scene.

Although an embodiment of the present disclosure has been described above, the present disclosure can be regarded as a communication control device, a method executed by a communication control device including a processor and a memory, a program for executing the method, a computer-readable non-transitory storage medium storing a program, and a system including a communication control device and a vehicle.

The communication control device and the like of the present disclosure are useful in a case where it is desired to change the frequency of communication with a plurality of vehicles.

What is claimed is:

1. A communication control device that controls communication with a plurality of vehicles, the communication control device comprising:
a communication unit that performs communication including acquisition of vehicle data with the plurality of vehicles;
a database that stores data for forming, on a virtual space, a digital twin that is time-synchronized with a real space, based on the vehicle data acquired by the communication unit; and
a control unit that controls a frequency of communication performed by the communication unit, wherein when there is a first vehicle of which a distance from a surrounding object is less than a first threshold value on the digital twin, the control unit increases the frequency of the communication performed with the first vehicle than when the distance between the first vehicle and the surrounding object is equal to or greater than the first threshold value.

2. The communication control device according to claim 1, wherein when there is a second vehicle of which a speed is equal to or higher than a second threshold value on the digital twin, the control unit increases the frequency of the communication performed with the second vehicle than when the speed of the second vehicle is lower than the second threshold value.

3. The communication control device according to claim 2, wherein when the first vehicle and the second vehicle are the same, the frequency of the communication is higher when the distance from the surrounding object is less than the first threshold value than when the speed is equal to or higher than the second threshold value.

4. The communication control device according to claim 1, wherein when a predetermined communication related to a third vehicle is requested, the control unit increases the frequency of the communication performed with the third vehicle than when the predetermined communication is not requested.

5. The communication control device according to claim 4, wherein when the third vehicle is parked, the control unit continues to increase the frequency of the communication until a predetermined time elapses after receiving a request.

6. The communication control device according to claim 4, wherein when the third vehicle is not parked, the control unit continues to increase the frequency of the communication until a request ends.

7. A system comprising:
a plurality of vehicles; and
the communication control device according to claim 1.

8. A method executed by a computer of a communication control device, the communication control device including a database storing data for forming, on a virtual space, a digital twin that is time-synchronized with a real space, to control communication with a plurality of vehicles, the method comprising:
a step of predicting a distance between the vehicle and a surrounding object on the digital twin;
a step of predicting a speed of the vehicle on the digital twin;
a step of increasing, when there is a first vehicle of which a distance from a surrounding object is less than a first threshold value on the digital twin, a frequency of the communication performed with the first vehicle than when the distance between the first vehicle and the surrounding object is equal to or greater than the first threshold value; and
a step of increasing, when there is a second vehicle of which a speed is equal to or higher than a second threshold value on the digital twin, the frequency of the communication performed with the second vehicle than when the speed of the second vehicle is lower than the second threshold value.
